(19) United States
(12) Patent Application Publication
(10) Pub. No.: US 2003/0082508 A1
(43) Pub. Date: May 1, 2003

(54) Training method

(75) Inventor: Matthew F. Barney, Hoffman Estates, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 10/012,622

(22) Filed: Oct. 30, 2001

(51) Int. Cl. G09B 19/00

(52) U.S. Cl. 434/308

(57) ABSTRACT

A training method wherein candidate students are optionally pretested to ascertain a present level of familiarity with a given trainable faculty and a profile is developed for that student as regards that student's contact information, present level of mastery, and other items of appropriate information. A personalized curriculum is then specifically developed for that student, which curriculum includes both a primary presentation 109 and a post-presentation plan 111. The post-presentation plan 111 includes the generation and transmission of automatically prepared messages 115 that can variously provide supplemental information to the student, query the student with respect to mastery, and notify or query others with respect to the student's apparent level of achieved mastery.

### TECHNICAL FIELD

This invention relates generally to training, including instruction intended for both general and specific (or vocational) subject matter and applications.

### BACKGROUND OF THE INVENTION

Most people participate, at one time or another, in a learning process as a recipient of the knowledge and/or skills that are being presented. Not withstanding this almost ubiquitous experience, research frequently indicates that such recipients often fail to achieve mastery of the topic in question (either immediately upon receipt of the information or within some reasonable period of time thereafter). This lack of effective training often becomes particularly telling in an employment context where an employee receives training in the form of knowledge and/or skills that should, at least theoretically, improve the employee's performance with respect to that employment.

Many factors are likely responsible for this failure to realize significant benefit from learning exercises. For example, some recent research suggests that two important factors in predicting training success are relevancy and transfer climate. Relevancy constitutes the recipient's perception that the information provided is critical to their own personal success (and, within the context of employment training, critical as well to the overall effectiveness of the organization). Transfer climate reflects a student's expectation of support. In an employment context, transfer climate includes expectation of support from supervisors, co-workers, upper management, and the like with respect to transferring new knowledge and skills into the employment context.

Frequently, significant disconnects can exist between those skills and that knowledge that will truly benefit a particular organization and/or an individual and the knowledge and/or skills that are actually offered to an employee or other training recipient. These disconnects, whether overtly understood as they often are or merely suspected can and will greatly impact upon a student's sense of relevancy, and hence detract from the effectiveness of the training. Further, transfer climates can and often will be relatively positive within a given formal educational context (particularly in a setting such as a classroom or educational campus). Sooner or later, however, students typically leave that environment. For example, employees who have taken time away from their normal work setting for training are eventually reintroduced back to the job. In many cases, the transfer climate immediately following the primary delivery of information to a student in this setting will not likely satisfactorily support the student This can occur through relatively benign circumstances, as when a student is simply unable to practice new knowledge or skills due to a lack of current necessity, or through more active means as when a supervisor openly discourages use of newly gained knowledge or skills.

One prior art approach to attempt to alleviate these circumstances requires substantial instructor effort following the presentation of material to ensure mastery. Such an approach is extremely labor intensive and hence prohibitively expensive and therefore rarely used in most circumstances. And, in fact, even such significant personal intervention by an instructor may nevertheless fail to overcome a lack of relevancy or poor transfer climate when those circumstances exist.

A need therefore exists for a way of increasing the relevancy of instructional material to a given student and for further shaping a transfer climate that more reliably moves a given student towards mastery of knowledge and/or skills.

### BRIEF DESCRIPTION OF THE DRAWINGS

These needs and others are substantially met through practice of the methods and systems as described below in detail. Various benefits and advantages of the various embodiments set forth below will become more clear upon making a thorough review and study of the following detailed description, particularly when considered in conjunction with the drawings, wherein:

FIG. 1 comprises a flow diagram depicting various embodiments of an overall training method in accordance with the invention; and

FIG. 2 comprises a flow diagram depicting various embodiments of a post-presentation plan as practiced in accordance with the invention.

### DETAILED DESCRIPTION OF THE INVENTION

Pursuant to at least one embodiment, a training system provides information regarding a topic to an information recipient. Subsequent to providing that information, the system then automatically forwards at least one message to that recipient. That message will include a query to test retention by the information recipient of the information earlier provided and/or will include information regarding the topic (which information may be supplemental to or a repetition of earlier provided information). At least in the case of the latter, the information provided is based upon an individual profile of the information recipient. This aids in ensuring provision of information particularly relevant to the recipient by focusing more intently upon information that the recipient is less likely to have fully mastered or for which the recipient is less likely to retain longer term mastery. At various points of achievement, partial or complete mastery can be recognized through certification or degrees as appropriate (of course, such recognition is optional and does not constitute a necessary element of every desirable embodiment). Various embodiments based upon or similar to this general approach are set forth below.

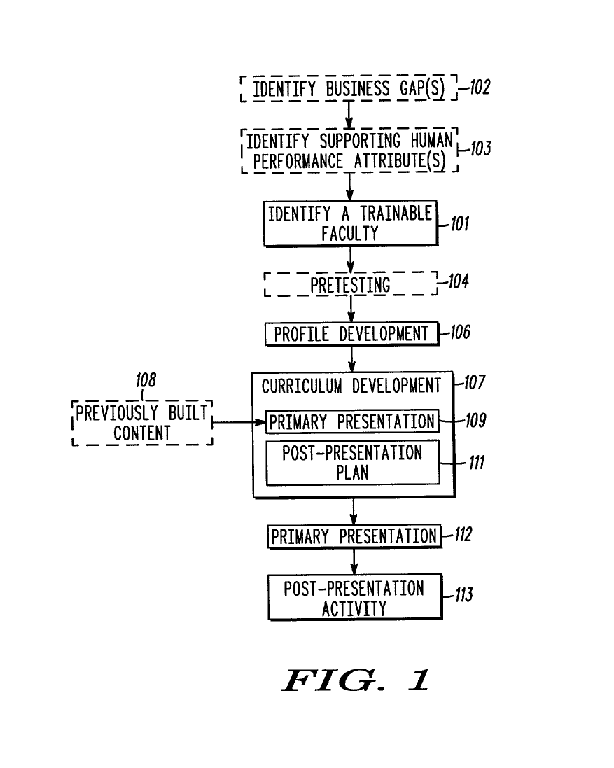

Referring now to FIG. 1, a number of embodiments for effecting training methods will be described in more detail.

In order to provide training with respect to a particular topic, there must of course first be a chosen topic. Consequently, this training method provides for identifying 101 at least one trainable faculty typically selected from a body of knowledge and/or skills. There are a number of ways to so identify 101 a trainable faculty. There already exists a significant number of already identified trainable faculties as constitute all or part of already established curriculum at various levels of education. To the extent that these teachings are applied in the context of, for example, an institution of higher education such as a university, the already existing disciplines and curriculum can constitute the baseline for identifying 101 the trainable faculties against which the embodiments taught herein are applied.

In other settings, however, such as a business setting, a somewhat different approach can be considered. One can begin by identifying 102 the business gaps that challenge a particular business. By identifying these gaps, and monetizing them in accordance with well understood prior art technique to allow appropriate prioritization, at least one articulated business gap can be identified 102. The embodiments taught herein can then be worked favorably against that gap to reduce or eliminate the business gap all together.

If desired, this approach can optionally include use of an Internet-enabled system that helps the instructional and assessment designer to dynamically create terminal objectives based on balanced scorecard goals for the business goals in question using an automated strategic work modeling tool. When using this approach, data throughout the process can be aggregated and summarized in the scorecard framework for executive review, to ensure that overall organizational goals are realized.

By capturing data that describes the cost, causes, and timeframe of the business gap, this approach allows the instructional designer or performance analyst to situate the instruction in the context of the business outcomes that the desired performance will produce on the business. This approach facilitates a diagnostic framework that allows the user to input the dollar value of the missed business opportunity represented by the gap as well as details about required performance (and the specific human performance attributes that are likely necessary to achieve such performance). In one embodiment, the system can process the key data using the algorithm below to show the achievable return on investment or the economic value added (EVA being a more recent form of Return On Investment that incorporates the cost of capital). This allows the user to establish a budget for the entire training project that is commensurate with the business value the effort will produce.

(Value)(Effectiveness)=Benefit

Value=(F)(P)(K)

Effectiveness=(E)(S)

therefore

(F)(P)(K)*(E)(S)=Benefit

where

F—financial size of business problem, in currency units (e.g. $)

P—percent of business problem causally due to human performance gap in target populations

K—percent of human performance gap due to knowledge or skill gap

E—percent of total desired human performance shift realized after mastery

S—percent of schedule execution from the business-driven end date to actual

If desired, the user can further take into account apriori estimates of the overall cost of producing the program, and/or OLE/ODBC/URL links to real-time databases of cost data. This feature would allow for the entire training system to: a) establish business relevancy for all knowledge and skills taught in the course(s); b) while simultaneously providing upper cost limit targets using activity based cost information in order to realize apriori economic value added or return on investment goals. Up front decisions can then be made to establish the fraction of value-added the training project should consume, and estimate apriori economic value added:

[(Benefit)−(Investment)−(Investment*Cost of capital)]/(Investment)

Such a system can systematically update these data in a graphical scorecard report for supervisors and other executives on-line to: a) track the overall learning effort from an overall organizational outcome point of view; and b) establish a clear and powerful link between the learning and business objectives.

Further, the system can encourage or require information from relevant business leaders about which scorecard metric(s) are the most important. For example, each identified senior business leader could be required to assign different weights against various identified metrics based on relative importance toward organizational success. Weights can be standardized (e.g. by using 100 points allocated across all metrics) so that these data can be used to analyze strategic work ratings as described elsewhere in these teachings.

Once a business gap has been identified 102, one identifies 103 the human performance attribute or attributes that will support the closing of that gap. Such human performance attributes include, for example, specific knowledge and/or specific skills. Such knowledge and skills can be general (such as overall familiarity with a particular area of knowledge such as basic mathematics or the metric system) or specific (such as the particular details associated with effectively utilizing a specific software program in a particular context). Once these human performance attributes that will support closing the identified business gap have themselves been identified 103, the trainable faculties that will empower an individual with the knowledge and skill necessary to effect those human performance attributes can be identified 101.

The information generated above can be used to substantially identify the performance causally responsible for the business gaps and clarify the trainable faculties needed to perform successfully. There are at least two approaches for accomplishing this, a taxonomy-based approach and a user-defined approach.

Taxonomic Approach

This embodiment uses a predefined hierarchically-structured taxonomy of work and worker attribute dimensions (e.g. O*Net). The user is queried to produce a list of subject matter experts (SMEs) (including names and contact information such as e-mail addresses) so that these individuals can be electronically contacted to request participation in a job analytic study. Surveys are automatically e-mailed to these SMEs (transmitted via a messenger system (e.g. AOL/MSN Messenger) or netcast using push technology) with an optional note explaining the importance of the study and inviting them to participate. The note can also include a hyperlink that they can click to take a work modeling survey. Once SME data are inputted, the remainder of the entire strategic work modeling process can be completely automated if desired.

First, this system uses the business context data to create new, business process outcome-focused scales. These scales are used to differentially calculate the importance of each work behavior and worker attribute. Second, the system can be completely automated because it exploits the hierarchical or cascaded nature of the taxonomy. In each refining review of the information on a computer monitor, the SMEs can determine whether or not each category of work and worker dimensions and tasks are required to realize the business goals before making any task or knowledge, skill, ability, or other ratings. For example, SMEs might identify that the job of a software engineer includes analytical but not physical tasks and abilities. By pre-selecting only those domains of work and worker attributes that are relevant, the system requests the SME to make task ratings on only those dimensions that are business relevant (e.g. using arrays in C++).

Next, the system receives input regarding the job relevance of more specific sub-categories only for areas that employees reported were relevant. This process continues for each sub-category, and sub-sub category, until the system identifies all job-relevant dimensions. Next, the system dynamically generates a survey to further refine the list of tasks, work context items, and corresponding knowledge, skills, and abilities. The scale used should include the business outcome data that comprise the driving reason for the course using text combined with the business context data. For example:

“Is this task required to produce [business outcome variable] at [goal level] by [end date]”?

This integration of the business outcome, goal level, and end-date information as part of the scaling of work and worker attributes is a significant improvement over technologies in the prior art that do not exploit relational database information to ensure that work analyses (and consequent products, like courseware) are focused on the business objectives.

Next, those items that were selected by the SME as job relevant and whose ratings meet the quality criteria described below are used to generate a linkage matrix. In this portion of the study, SMEs rate or link each requisite faculty (trainable and untrainable) (including for example knowledge, skill, ability, trait, value, or interest) required to either successfully perform each work task or to use each tool determined important in the previous stage. Implemented as suggested, this matrix generation can occur without human intervention.

User-Defined Approach

An alternative embodiment allows a performance analyst to define the work and worker attributes to be included in the scale. This embodiment includes a computer along with necessary interfaces such as a monitor, keyboard, and mouse that allow the creation of a set of work and worker attributes that SMEs later rate using the same business-outcome metrics defined above. This embodiment may be well suited to scenarios where pre-existing job descriptions or competency models already exist and there is no need to start from scratch.

With either of the embodiments described above, the fully automatic capabilities of this system can enable an entire strategic work model to be completed in as little as a few minutes, as contrasted with typical prior art approaches that require days or weeks because of required manual work. Automated Strategic Work Modeling Problems and Solutions

The first embodiment presented above poses a problem in analyzing the resulting data when SMEs select different dimensions from different categories. The omission of any dimension in initial reviews can preclude items subsumed within those omitted categories from being rated. Further complicating the analysis, different raters may choose slightly different dimensions for any job, particularly when different SMEs have different motivational levels, attention spans, and knowledge about performance requirements. Analytically, this approach causes different items to have potentially very different sample sizes, and consequently, varying amounts of error variance in each metric. A number of solutions can be applied depending upon the particular circumstances and application.

Solution 1

Software-based decision rules can be used to improve the data quality by allowing the designer to pre-configure minimum quality criteria to be used in subsequent automated analyses. An interface has defaults and user-customized choices for different minimum sample sizes, and standard error thresholds. These parameters specify what data to include in each analysis, and whether or not the result can be automatically interpreted. If the parameter thresholds are not met, then the system notifies the user that manual analysis is required. The system uses these parameters to generate a final job analysis report once all job analysis surveys are complete. Importantly, the decision rules incorporate multidimensional termination criteria, so that the system reports when the results are not interpretable (e.g. too small of a sample size of persons with experience).

Solution 2

The surveys this system creates should be short enough for most people to complete. In manual approaches available in the prior art, the job analyst makes this judgement before a survey is ever sent out to an SME, but with an automated system, the system must have an alternative. For example, a confirmatory survey that determines 45 tasks, 5 tools, and 50 knowledge, skills, abilities, and other personal characteristics to be crucial could likely generate a linkage survey requiring, for example, 2,500 judgments from every SME For most settings this is an unreasonable amount of work for any SME to do on their own, and few would complete such a survey.

By one approach the system could automatically split the linkage matrices into pre-established reasonable sizes (e.g. ˜100 judgments per SME) by asking the SMEs to rate the entire set of tasks but only a subset of the remaining items. This approach would likely require the user to select a pre-established deadline (date and time) for all automated confirmatory survey data to be complete, at which time the system would create linkage surveys and notify the same or new SMEs about the need to complete the new survey. This approach, however, can under some circumstances adversely impact the sample size and heterogeneity of variance problems identified earlier. Also, this approach has the potential to be inherently slower since the linkage matrices cannot be completed until either the termination date occurs or the last SME completes the confirmatory survey.

By another approach the system will query for ratings at a higher level of abstraction than was present in the confirmatory survey. For example, the system may examine the survey length after omitting the detailed abilities “short term memory” and “long term memory” and substitute their corresponding category heading, “Cognitive Ability.” This solution, however, can result in some subjects' data being at a lower level of analysis than others. In particular, subjects that are very detailed in the selection of dimensions and tasks in the confirmatory stage are more likely to get abstracted category headings in the second, linkage matrix, survey.

Pursuant to yet another approach, previous research (e.g. from the O*Net archives) can be used to pre-establish a subset of the links and only ask questions about missing links. For example, there may be a substantial amount of data on cross-functional skills, abilities, and traits already known to be critical to performing certain tasks, and the only ratings needed are the particular knowledge domains required to perform effectively.

Of course, a hybrid of the three approaches noted above is also within the spirit and scope of the current embodiment and available as an option to the user.

Solution 3

One potential concern with a completely automatic approach is that passive automation without human supervision may hinder rigorous sampling plans, resulting in a probable loss of validity. This concern is a non-issue, of course, in the rare case where the entire population of incumbents is required or desires to be included in the job analysis study. For the more likely cases where SMEs self-select (and deselect) themselves to be in the study, additional features may at least partially address this problem. In one embodiment, the system only allows SMEs to complete the survey who meet minimum quality criteria as established for the survey. These would include SMEs who are experienced on the job (represented, for example, by experience for some predetermined minimum period of time), are motivated to give good information (defined, for example, by their score on an infrequency scale), and/or are good judges (as might be indicated, for example, by individuals who score “field independent” on a test of field dependence/independence). Each of these approaches is discussed in more detail below.

The fully-automatic approach to job analysis frequently requires that demographic data be collected about the SME's ability to make a good rating, such as number of years of experience, current job position, and past jobs. The system can automatically scan these data, as entered by each SME (and/or as obtained through whatever other sources may be available), to quality control the SME type in several ways. First, the user can elect to have the system prevent low-experience (or other undesirable characteristic) SMEs from filling out the survey. Second, if the first option is politically (or logistically) infeasible, it can allow unqualified SMEs to fill out the job analysis survey, but later drop (or weight unfavorably) their ratings from the study. Third, the system can be configured to drop SME ratings only after statistical comparisons are made with respect to how the data changes when inexperienced (or other variables) SME's data are included or dropped (for example, if substantially identical results are obtained with or without inclusion of data as obtained from suspect SMEs, a decision can be made to include the data (and thereby avoid, for example, potential political or other considerations). An alternative embodiment can provide for notification of job analysts by e-mail or other means that all further analyses are on hold until they give some guidance.

As a supplemental or alternative approach, additional scales can help control for at least some variability in judgment quality. For example, various questions about the motivation of the subject can help ensure the quality of the data (e.g. infrequency and social desirability items) so that data from subjects who are more likely to not be paying attention or who are otherwise disinclined to provide informed and attentive input are discarded. Another approach that can be included to improve the data quality in the automated system would be to include field dependence/independence (FD/FI) items. The FD/FI construct has been shown to reliably predict the quality of ratings given by people under many circumstances. FD/FI tests can be administered prior to job analysis scale administration, and then be used to prevent low cut score SMEs from proceeding. Alternatively (and more discreetly), the aggregate FD/FI dataset scores can be automatically parsed out of the job analysis dataset scores. The parsing approach requires the automated system to have a pre-programmed maximum timeframe/time clock in which to conclude the study, so that this information can be used to perform the parsing calculations, transform the scores using semi-partial correlations, and give a final report

Lastly, the full-auto embodiment must have ultimate minimum requirements for its' ability to interpret the data from the job analysis (e.g. sample size after throwing out unqualified SMEs) so that naive users do not use the system inappropriately.

Once pre-established limits, analyses, and other quality control devices as described above are used successfully on the first job analysis survey, the system can use all or many of the same SMEs to complete the resultant linkage matrices. This is a significant benefit because SMEs are scarce and securing them for a second set of surveys is often difficult.

Solution 4

Organizations generate new information that is relevant to business success, and this often changes the success factors for employees. A fully automated career defining system should ask SMEs, after the initial survey is administered, to report any knowledge or skills that are critical to the job, but were not asked about on the survey. A job analysis wizard system (such as is taught and disclosed by U.S. Pat. No. 6,070,143, incorporated herein by this reference) uses an expert analyst to review SME reports of missing dimensions and ultimately to update the master skills dictionary using Fuzzy Indices of Dissimilarity (FIDs) by placing them in a rational spot in the hierarchy. A fully automated version should capture, in software, decision algorithms used by the analyst to make the same sorts of judgments.

Before simply using a software version of the decision processes, one uses SME judgement to help minimize taxonomy redundancies and determine appropriate placement The system manages SME judgments by having each expert review: a) a short list of dimensions that automatically reveals 2 to 3 TTKSAOs (Tasks, Tools, Knowledge, Skills, Abilities, or Other personal characteristics such as values, interests, or traits) that appear to be the same or similar as are already present in the skills dictionary; and b) other SME's reports of missing dimensions.

The system processes the results based on three possible outcomes. First, if the SME identifies that a dimension is already present in the dictionary, it administers the corresponding scales. Second, if the SME discovers that other SMEs have already reported and rectified the omission, the system would have already administered that item to them as a normal part of scale administration (as described in the outcome below) so the system can acknowledge and thank them for their input and notify the researcher that the subject has completed the study. Third, if the TTKSAO is truly new, the system asks the SME to enter it carefully and make ratings on it using scales appropriate to its' data type (e.g. knowledge scales for new knowledge dimensions). In an Internet Web-based embodiment the system can automatically force all future Web-based surveys to administer that same scale to all other SMEs who have not finished their survey for that same job. Once all surveys are complete, the system can use a variety of matching algorithms, including but not limited to the Fuzzy Indices of Dissimilarity as disclosed in the job analysis wizard referenced above to determine appropriate placement in a hierarchical skills dictionary. New Data Analysis Approach for Multidimensional Criteria

This approach uses scales that incorporate business data as earlier developed that are the fundamental reason for action. These outcome data (e.g. scorecard metrics) are usually multidimensional. This approach uses a new data analysis technique to examine strategic modeling data collected from this strategic business context scale. First, work activities that are rated as unimportant toward impacting all strategic measures are automatically eliminated using the system's pre-determined minimum threshold limits previously mentioned.

Second, this embodiment uses the earlier created business metrics and importance weights to create a new type of analysis to sort the importance of performance dimensions. This new analytic technique highlights, for the benefit of subsequent processing, those work and worker attributes that are most critical toward realizing the most number of business outcome goals, allowing the designer to emphasis the most important performance Each performance area's ratings are algebraically combined (weight*rating) and then sorted and shown via computer screen in a Pareto chart using the following algorithm:

For each Proficiency: Sum (rating_{x*} Business Metric Weightₐ)

For all x with ratings on each Metric goal, a

These embodiments can be used in a wide range of businesses and organizations. For example, a manufacturing organization may seek to improve two particular business metrics, yield (e.g. to 0.95) and cycle time (e.g. 15 day improvement). Business leaders may indicate that cycle time is slightly more important than yield (e.g. 60% weight for cycle time, 40% for yield). The strategic work modeling effort might identify three performance areas that are constraining the objective. In Table 1 below, each proficiency is listed, with mean ratings (1-7) of their impact on yield and cycle time metric goal attainment (the Taguchi referred to below is a Japanese statistician who identified methods to do rapid, valid, optimization experiments; this example is used simply to suggest that the experimental design proficiency should preferably include using such research design techniques to fulfill the yield and cycle time goals):

TABLE 1

| | Mean of Yield | Mean of Cycle |
|---|---|---|
| Proficiency | Ratings | Time Ratings |
| Designs split-plot experiments | 6.7 | 2.3 |
| using Taguchi methods | | |
| Optimizes process flow using | 3.4 | 5.5 |
| linear programming | | |
| Incorporates hyper-greco latin | 5.1 | 4.9 |
| squares in experimental designs | | |
| to optimize process | | |

In this example, the first proficiency is most directly related to impacting yield, the second to cycle time, and the third is roughly equal in impact across both. As presented in Table 2 below the system calculates the weighted importance of each proficiency using the formula above:

TABLE 2

| | | | Overall |
|---|---|---|---|
| | | | Proficiency |
| | | Weighted | Importance: |
| Proficiency | Weighted Yield | Cycle Time | Sum |
| Designs split- | (6.7) * (0.4) = 2.68 | 2.3 * (0.6) = 1.38 | 4.06 |
| point | | | |
| experiments | | | |
| using Taguchi | | | |
| methods | | | |
| Optimizes | (3.4) * (0.4) = 1.36 | (5.5) * (0.6) = 2.04 | 4.66 |
| process flow | | | |
| using linear | | | |
| programming | | | |
| Incorporates | (5.1) * (0.4) = 3.3 | (4.9) * (0.6) = 2.94 | 4.98 |
| hyper-greco | | | |
| latin squares in | | | |
| experimental | | | |
| designs to | | | |
| optimize | | | |
| process | | | |

This process can then sort the three proficiencies into a Pareto Chart where the third proficiency is first, since it has the largest overall impact on both cycle time and yield

This system displays the priority of work activities connected to the highest-weighted business metrics first and cascading down to those that are connected to lesser-important ones, a hybridized Pareto chart. It is within the spirit and scope of this invention to include in this analysis proficiencies that only have ratings on a subset of the total outcome metrics. Proficiencies with links to only a few (e.g. one) business metrics will likely have smaller sums than those with links to nearly all metrics and would fall appropriately in the sorted Pareto chart according to their diminished importance. Alternatively, unique weighted Pareto charts can be generated separately for each outcome criterion. The system saves the final strategic work model so that all instructional and assessment efforts accomplished in subsequent steps are based on driving all learner's proficiencies toward this prioritized framework of expert performance.

The automated system can e-mail or post on a Website the results of its' findings for a human to evaluate using the format required by the U.S. Government's Uniform Guidelines for Employee Selection Procedures, the legal standard for job analytic information storage. Once complete, immediate hyperlinks to pre-existing materials or knowledge banks (e.g. courses, job aides, communities of practice, tests, interviews, ADA accommodations, and so forth) are available for the human user to evaluate and download for immediate use.

Some of these approaches off-load at least a portion of cognitive work away from the job analyst and onto the SME. This may be desirable when the job analysts' time is scarce or expensive, or there is a very high volume of jobs requiring analysis. At the same time, SME opportunity costs are often higher than the job analyst costs (especially in high-technology areas) so the full-auto embodiment should be used with thought and care. This approach can still require a job analyst to review the linkage data and ultimate final automated job analysis report in order to add new dimensions as appropriate (e.g. using an artificial intelligence decision aide in the job analysis wizard). A fully (or substantially) automatic embodiment, however, can use the top artificially intelligent-based recommendation from the fuzzy decision system as included in the job analysis wizard.

Also, using a fully automated job analysis approach with generic, pre-specified cut-off thresholds is likely to be inappropriate in some situations. For example, employee survivors of employee downsizing or disgruntled labor unions engaging in a work slowdown or other forms of sabotage may skew the mean to be far lower than the pre-established thresholds allow, or may introduce too much error variance to be useful. The results of fully automated approaches therefore should almost always be interpreted—sometimes cautiously—by skilled job analysts.

This process can yield anywhere from one to a large number of identified trainable faculties. To the extent that a significant number of trainable faculties are so identified 101, typically an order of receiving training for these trainable faculties will necessarily follow as most typically training cannot be simultaneously provided for all of the trainable faculties at once.

Optionally, once the trainable faculties have been identified 101, the intended recipients of the training can be pretested 104. Such pretesting can serve a number of purposes. For example, intended recipients can be pretested in order to obtain pretesting information regarding their present knowledge of the identified trainable faculty. The resultant information can then be utilized to facilitate preparation of a customized curriculum as disclosed below. (Another possibility, of course, is that a given intended recipient may already have a mastery level of achievement with respect to a given trainable faculty and such pretesting may illuminate this situation and avoid the inefficiencies of providing such an individual with unnecessary training.) Another important potential purpose of pretesting is to obtain pretesting information regarding necessary and potentially prerequisite attributes that are, for whatever reason, substantially untrainable faculties. For example, certain trainable faculties may be known to be typically unsuccessfully imparted to individuals bearing a particular personality trait (or, conversely, lacking one or more particular identified personality traits). To the extent that a particular personality trait remains relatively static for an individual and is not otherwise generally amenable to training, pretesting with respect to such an attribute can aid in avoiding the inefficiencies of providing training to an individual when that training is unlikely to benefit either the individual or any other organization.

A profile is developed 106 for each of the intended recipients. At a minimum, this profile includes identifying information for each recipient along with specific contact information for such individuals. In particular, this contact information should include specifics regarding ways to communicate with the recipient following a primary presentation of material as disclosed below. The purpose of these communications will be made more clear below, but typically are best rendered when wireless data communications are available and utilized. This being so, the profile should include at least the contact information as pertains to the wireless data conduit (for example, if the recipient has a two-way pager, the wireless address for that two-way pager should reside in the profile in correspondence to the identifying information for the recipient).

If the recipient has undergone pretesting 104 as described above, or if any other information is available regarding the recipient and their presumed state of knowledge (such as might be available from educational institution transcripts, internal training records, resumes, and performance reviews) such information can also be appropriately retained within the profile. Such information can be utilized both to develop a specific curriculum for primary presentation to the recipient as well as architecting a post-presentation plan for that particular recipient as described below. Again, to the extent that this information indicates levels of exposure and/or mastery regarding the identified trainable faculty, such information can be utilized to appropriately customize and target the curriculum contents.

A curriculum is then developed 107 for the intended recipient. This curriculum utilizes whatever information the profile contains and will also typically benefit from previously built content 108 as may be available. As a simple example, when the trainable faculty constitutes basic math, the previously built content 108 can include existing curriculum with respect to instructional plans and materials for addition, subtraction, multiplication, and division. If a given individual, however, has a profile indicating already attained mastery with respect to addition and subtraction, the curriculum for that given recipient can modify the previously built content 108 at least to the extent of minimizing time and attention paid to addition and subtraction skill while emphasizing multiplication and division skills.

The curriculum includes both a primary presentation 109 and a post-presentation plan 111. The primary presentation constitutes a body of material designed to instruct a recipient with respect to the area of knowledge or skill that corresponds to mastery of the identifiable trainable faculty. This primary presentation 109 will ordinarily be presented 112 in a formal instructional context such as a dedicated classroom, a temporary classroom, or a virtual classroom (such as occurs when a group of geographically distributed students participate in a common training experience through a shared medium such as an audio link, an audio/video link, or an Internet-based experience). The formal instructional context can also include an individual study scenario where an individual works through the curriculum essentially on their own as guided or supplemented through audio materials, audio-visual materials, or an Internet-based experience or the like. The primary accouterment of this formal instructional context is that the recipient is knowingly engaged in an educational endeavor to the exclusion of other activities, priorities, and distractions. Once the recipient has received the primary presentation 112, post-presentation activity 113 becomes active.

This embodiment can customize development content that depends, at least in part, on the proficiency level of the learner, the performance the business requires (as defined above), and the type of wireless devices the information recipient ordinarily uses (or otherwise can feasibly use) on the job (or otherwise outside of the formal education context). The content can be developed using other authoring devices (such as Authorware and Toolbook) or standard text files that can be linked with specific proficiencies and proficiency levels for different types of delivery media. The type of instruction delivered can be customized to be appropriate given the bandwidth constraints of the device(s) the information recipient will use. Students can receive plain text instructions on how to use the course concepts on the job or practice using their skills with a real-time simulation (using, for example, executable software files). Further, content can include non-traditional forms of learning such as out-of-class exercises (e.g. delivering a stand-up presentation on a job-related topic), relevant Web sites, bulletin boards, and user groups, handy job aides (e.g. *.gif and *.jpg files showing a review of course concepts), and/or customized feedback about areas for improvement defined by periodic assessments.

Such a system allows a user to administer additional post-course assessments via e-mail, WAP-enabled cellphone, pager, personal digital assistants, or otherwise through the Internet to quantitatively assess proficiency as compared with the expert model defined during earlier activities noted above, and further customize additional follow-up instruction if needed. This allows for additional course evaluation measures typically unavailable with traditional instructional approaches.

Additionally, such a system can dramatically improve post-course activity support and accountability in at least a business context by actively engaging managers to ensure detailed transfer climate support, a known key driver of training transfer. By automatically reporting an employee's progress to their supervisor and providing customized, detailed coaching advice to a relevant supervisor, the system helps the supervisor provide relevant feedback, rewards, and other follow-through beneficial and/or necessary for skill mastery. At the same time, the device can assess the supervisor's ratings of current performance to improve the fuzzy profile and further identify whether or not the recipient has mastered the target performance.

The designer can set a timeline across which the supervisor receives reports to help ensure that the supervisor provides the most helpful, customized transfer climate available across a long-enough period of time that the skills are mastered. Further, the system makes it easy for the supervisor to continue to monitor the progress of the employee's skill building, and diagnose other causes for performance problems (e.g. work environment). The system also can integrate these data with scorecard or dashboard frameworks created or generated from the initial stage. In addition, the user can have input into scheduling the frequency of deliveries of eLearning content and assessments (e.g. multiple times a day as versus once a quarter and so forth).

Additionally, the system can employ Internet (or intranet)-based communities of practice to both allow recipients and instructors to overcome the challenges of using course concepts in the real world outside the confines of a formal educational context. Further, knowledge communities can provide avatars that notify the recipient when new recommendations are made on designated community boards that match key development interests or needs. One embodiment can include automated assessments and interventions that are e-mailed to the student (e.g. simulations, job aides) that require or encourage the student to participate in on-line discussion groups. This would further enhance the recipient's encoding of knowledge or skill to long-term memory and ensure the generalizability of skills to new situations (e.g. that other recipients or participants have already encountered or considered).

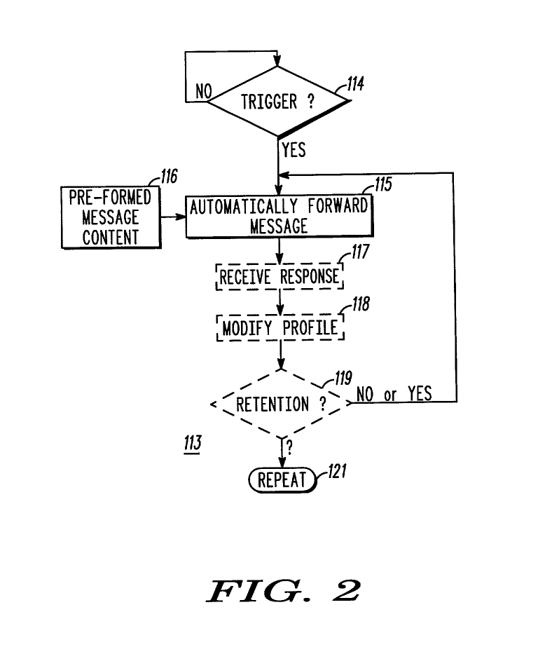

Referring to FIG. 2, post-presentation activity 113 can be viewed as functioning in response to detected triggers 114. These triggers can be many and varied. For example, the passage of time can be monitored with predetermined intervals constituting detectable triggers. Another trigger can be achieved by sensing a particular condition or event that indicates a likely near-term need for specific necessary knowledge or skill. For example, if an impending maintenance activity for a given apparatus can be sensed, that event can be utilized as a trigger with respect to a recipient who has received training that correlates to providing such maintenance. Other triggers are possible as well, including reacting to indicia obtained through various sources that indicate that a particular recipient of information is perhaps displaying behaviors or accomplishments that suggest a potential lack of understanding of at least some of the previously supplied material. Such indicia could come, for example, from a supervisor or quality inspector in an employment context or from a teacher or professor in an educational context. Many other triggers are of course available or conceivable as well and can be readily utilized when appropriate to a given scenario.

Upon detecting such a trigger 114, a message is automatically forwarded 115. In a preferred embodiment, this message is forwarded utilizing a digital data wireless connection, such as a two-way pager, a personal digital assistant that can receive wireless e-mail, and so-forth. Though less preferred, other paths can be utilized as well, including a wired communications path such as ordinary e-mail or even facsimile transmissions.

When directed to a recipient of previously supplied information, the message will typically include either a query or additional information regarding the original topic. A query can be utilized to test retention by the information recipient of the information originally provided and/or of other information that can be reasonably expected to now be known to the recipient if the recipient has successfully begun utilizing the knowledge and skills previously imparted. Additional information, when provided, can either be repetitive as compared to information previously supplied, or supplemental. In either case, the information can either be complete as transmitted, or the message itself can constitute a means for facilitating obtainment of such information by the recipient. For example, the message can include a hyperlink to a website containing the information. Or, the message can include information regarding a seminar or other gathering where the information of interest will be presented. Or the message can include information regarding additional materials (including previously existing or newly released articles, books, and other publications) that deal with the topic in question.

Importantly, at least some of the messages as automatically forwarded 115 to a recipient include pre-formed message content 116 that was originally developed during the curriculum development 107 described above. For example, specific queries (and answers) can be drafted during the curriculum development process. By having such content 116 available, the post-presentation activity 113 can be more readily effected in an automatic fashion. That is to say, a human supervisor or instructor need not participate in electing, realtime, when to send particular content or electing which content in particular to send.

On the other hand, in addition to using such pre-formed message content 116, the post-presentation activity 113 can itself also draw upon the contents of the recipient profile as developed 106 earlier in the process. If the profile is kept current with respect to present appearances regarding mastery of the information, then that profile can be utilized to either confirm continued mastery or to test continued mastery. As mentioned previously, one way to update the profile is by using supervisory ratings of performance after the development activity is complete, or after all faculties are improved to the desired level. The profile content can also be utilized to ascertain whether weaker achievements have become stronger, remained the same, or worsened, since the primary presentation 112. For example, if the profile indicated mastery of multiplication and acceptable but non-exemplary achievement with respect to division, the message to the recipient can constitute a query to test either skill in order to assess present levels of capability.

In the alternative, the message, instead of being automatically forwarded 115 to the previous information recipient, can be routed instead to a second person that is not the information recipient. This second person can be, for example, a supervisor, an instructor, a co-worker, a classmate, a peer, a customer, or a supplier, to name a few. The identity, relationship, and contact information for such individuals can again constitute information that is retained in the profile for a given information recipient. The message as forwarded to such an individual can comprise, for example, a questionnaire to assess the apparent success or inability of the information recipient to successfully exhibit mastery of the knowledge and skill in question. Or, the supervisors can automatically be sent customized coaching reports with specific behavioral steps the supervisor can take to reinforce and ensure successful mastery of information by the recipient and hence successful employee performance.

Whether the message is sent to the information recipient or to a second, third, or more persons as described above, when the message requires a response, the response is received 117 and that information utilized to assess the present capabilities of the information recipient and to modify 118 that recipient's profile accordingly. A conclusion may then be drawn regarding whether that recipient presently retains 119 an acceptable level of mastery of the information (when insufficient information exists to reasonably make such a conclusion, the process can simply repeat as appropriate until sufficient information exists to allow a definitive conclusion). When a conclusion can be made regarding unacceptable retention of knowledge or skills (or, in the appropriate context, anticipated attainment of such mastery), a message can again automatically be forwarded 115 to, for example, an instructor or supervisor to alert such individuals that the recipient is not succeeding. That information can be utilized as appropriate to further direct and assist the recipient towards mastery or other resolution of the situation.

There are at least two alternative embodiments that allow for fuzzy proficiency estimation and consequent assessment or content tailoring. In the first method, an adaptive variant of Classical Test Theory is used to estimate theta, the unique fuzzy proficiency estimate for each student in each performance area required by the business. This will often be a preferred approach for scales that have no validity data depicting item characteristic curves' statistical properties.

With this approach, a recipient's personalized fuzzy proficiency estimates (theta) are initially all set at zero before administering any assessment Using the pre-test, the fuzzy proficiencies can be estimated using scales and standard deviations for each proficiency area as a first estimate. This first data feed creates theta equal to the mean (M), and a stability score equal to the standard deviation (SD). Both theta and the stability score can be periodically updated each time a new assessment is taken using a mean and standard deviation recalculated from raw scores to ensure that fuzzy proficiency estimates and stability scores are refreshed using the complete set of information about the recipient's performance as new items are administered. The initial mean (or theta) and standard deviation (or stability) can be calculated (for each proficiency area) as:

Proficiency A: Initial Mean=[SUM (i₁:iₙ)]/n

Initial SD=Square root[Sum (i₁−iₘₑₐₙ)/n−1]

where i=observed score and n=sample size.

As the recipient goes through the initial assessment and content mini-assessments can be administered, where items from parallel scales are administered to update theta and the stability score's value, by recalculating using the new, additional raw data. Prior to certification, if the recipient's fuzzy proficiency assessment (as may be assessed in one embodiment by referring to the corresponding Theta and Stability scores) falls below the pre-determined minimum proficiency, the recipient can be required to either review previously received material and/or receive different material until their proficiency theta and stability estimates reach or exceed the minimum required. This process can continue until an overall mastery or certification test verifies that theta and stability scores for all proficiency dimensions have reached the minimum threshold proficiency.

Throughout the process, even though activity-level minimum means and standard deviations drive progress to additional activities and steps, the recipient's personalized theta and stability arrays can be continually updated. Once certified, each recipient will have some theta estimates for proficiencies with higher means and lower standard deviations than others, even though all meet minimum requirements. Next, each recipient's data is compared with the proficiency profile of expert performers and sorted by lowest mean and highest standard deviation to identify each person's unique areas for improvement. The bigger the delta between the expert mean and standard deviation and the recipients, the bigger the theta and stability gap. Pursuant to one embodiment:

If Mean (expert)−Mean (student)<0; or

If Standard Deviation (expert)−Standard Deviation (student)<0+/−a predetermined tolerance (e.g. 0.2);

then there exists a theta or stability gap between the recipient's desired performance and expert (mastery) performance.

A theta or stability gap represents an opportunity to develop/reinforce performance. Alternatively, if expert performer's data aren't available, minimum mastery theta and stability levels can be articulated such that follow-up exercises, instruction, and assessments continue until each recipient reaches the minimum estimated mastery levels for each proficiency area. Note that any recipient's estimated mean and standard deviation must both be at expert performer levels before this embodiment turns off additional development and assessments. Proficiency must be demonstrably and consistently high before being considered fully mastered.

In an alternative approach, a variant on Item Response Theory estimates Item level theta and standard deviation dynamically, and administers different numbers of items depending on the estimate of the validity of the assessment. In this embodiment, standard Item Response Theory (IRT) techniques available in the prior art can be used in tandem with the fuzzy difference scores listed above to sort and identify proficiency gaps that are worthy of further reinforcement by additional content, exercises, and so forth.

While there have been illustrated and described particular embodiments of the present invention, it will be appreciated that numerous changes and modifications will occur to those skilled in the art, and it is intended in the appended claims to cover all those changes and modifications which fall within the true spirit and scope of the present invention.

I claim:

1. A method comprising:
within a formal instructional context:
providing information regarding a topic to an information recipient;
within a post-formal instructional context and subsequent to providing the information to the information recipient:
automatically forwarding at least one message to the information recipient, which at least one message includes at least one query to test retention by the information recipient of information regarding the topic.

2. The method of claim 1 and further comprising:
receiving a response to the at least one query from the information recipient.

3. The method of claim 2 and further comprising:
automatically using the response to prepare a message regarding a trainable faculty of the information recipient to at least a second person, which second person is not the information recipient.

4. The method of claim 2 and further comprising:
when the response indicates at least a potential lack of retention by the information recipient, automatically using the response to identify information to convey to the information recipient regarding the topic.

5. The method of claim 1 and further comprising:
providing a profile of the information recipient, which profile includes at least some information regarding at least one trainable faculty of the information recipient.

6. The method of claim 5 wherein providing information regarding a topic to an information recipient includes providing at least some information that has been individually selected regarding the topic for the information recipient wherein the individual selection is at least partially based upon information in the profile.

7. The method of claim 5 and further comprising:
receiving a response to the at least one query from the information recipient;
using the response to modify the profile.

8. The method of claim 5 and further comprising:
receiving at least one message from a second person, which second person is not the information recipient and which second person interacts with the information recipient in the post-formal instructional context;
using the at least one message to modify the profile.

9. The method of claim 1 wherein automatically forwarding at least one message to the information recipient includes automatically forwarding at least one message to the information recipient using a wireless communications path.

10. The method of claim 9 wherein using a wireless communications path includes using a wireless two-way digital communications path.

11. The method of claim 1 wherein the formal instructional context includes at least one of a classroom and a virtual classroom.

12. The method of claim 1 wherein the post-formal instructional context comprises an employment context.

13. The method of claim 12 and further comprising:
identifying at least one business gap for the employment context;
identifying at least one human performance attribute that will facilitate addressing the at least one business gap;
identifying at least one trainable faculty that is substantially necessary to provide the human performance attribute; and wherein providing information regarding a topic to an information recipient includes providing information regarding a topic addressing the at least one trainable faculty to an information recipient.

14. A method comprising the steps of:
prior to conveying information regarding a topic to an information recipient in a formal instructional context:
providing at least one identified trainable faculty that will support facilitation of at least one human performance attribute;
providing a profile of the information recipient regarding at least a level of mastery regarding the at least one identified trainable faculty;
using the at least one identified trainable faculty and the profile to create:
a customized curriculum to present to the information recipient regarding the topic in a formal instructional context;
at least one query to be automatically transmitted to the information recipient in an employment context subsequent to conveying information regarding the topic to the information recipient in the formal instructional context to assess at least retention of some information regarding the topic.

15. The method of claim 14 wherein providing at least one identified trainable faculty includes providing at least one identified trainable faculty selected from one of knowledge and skills.

16. The method of claim 14 and further comprising:
pretesting the information recipient to obtain pretesting information regarding present knowledge regarding the at least one identified trainable faculty;
using the pretesting information to facilitate providing the profile of the information recipient.

17. The method of claim 14 and further comprising:
pretesting the information recipient to obtain pretesting information regarding at least one necessary untrainable faculty.
